(19) United States
(12) Patent Application Publication
(10) Pub. No.: US 2022/0326906 A1
(43) Pub. Date: Oct. 13, 2022

(54) SYSTEMS AND METHODS FOR DYNAMICALLY SYNTHESIZING AUDIO FILES ON A MOBILE DEVICE

(71) Applicant: Karl Peter Kilb, IV, Lords Valley, PA (US)

(72) Inventor: Karl Peter Kilb, IV, Lords Valley, PA (US)

(21) Appl. No.: 17/713,777

(22) Filed: Apr. 5, 2022

Related U.S. Application Data
(60) Provisional application No. 63/172,562, filed on Apr. 8, 2021.

(51) Int. Cl. G06F 3/16; G10L 15/22; G10H 1/00; G10L 19/018; G10L 25/48

(52) U.S. Cl. CPC G06F 3/165; G10L 15/22; G10H 1/0008; G10L 19/018; G10L 25/48; G10L 2015/223; G10H 2210/076; G10H 2240/325

(57) ABSTRACT

Embodiments of the present invention provide for systems and methods for dynamically synthesizing audio files on a mobile device. Embodiments of the present invention are directed to an exemplary audio file recorder with unique music-related features, such as synchronization of multiple pieces of content by the beats per minute, with functionality for content creation, editing, layering of multiple tracks, and sharing. Further, embodiments of the present invention are also related to an exemplary computer software platform which allows users to record any audio into their mobile device and organize the audio files in a manner that allows the files to be easily retrieved and shared.

### CROSS-REFERENCE TO RELATED APPLICATION(S)

This application claims the benefit of U.S. Provisional Patent Application No. 63/172,562 which was filed on Apr. 8, 2021, all of which is incorporated by reference in its entirety.

### FIELD OF THE INVENTION

The present disclosure relates generally to systems and methods for dynamically synthesizing audio files on a mobile device.

### BACKGROUND OF THE INVENTION

Currently, music producers have to use complex digital audio workstation devices and/or computer applications in order to record, edit, and produce audio files. In this regard, the digital audio workstation devices tend to be bulky and the digital audio workstation computer applications are generally energy and memory intensive. Further, the size and/or energy and memory requirements of such systems usually necessitates that they are kept “plugged-in” (e.g., connected to an outlet) at all times, thereby preventing users from using such systems to record, edit, or produce any audio files while they're on-the-go. Further, although certain mobile devices have voice recording capability, e.g., through a voice recorder mobile application, it is generally very limited and incapable of editing and/or producing synthesized audio files efficiently.

Accordingly, there is a need for systems and methods for dynamically synthesizing audio files on any mobile device, including, for example, a mobile phone, laptop, tablet/iPad®, etc.

### SUMMARY OF THE INVENTION

Systems and methods are therefore described herein that overcome the problems described above. In this regard, embodiments of the present invention are directed to an exemplary audio synthesization system with unique music-related features, such as synchronization of multiple pieces of content by the beats per minute (BPM), with functionality for content creation, editing, layering of multiple tracks, and sharing. Further, embodiments of the present invention are also related to an exemplary computer software platform implemented by a user's mobile device (e.g., mobile phone, laptop, tablet/iPad®, etc.), which allows users to record any audio into their mobile device and organize the audio files in a manner that allows the files to be easily retrieved and shared. In this regard, the exemplary software platform can provide the following capabilities to a user's device: a modifiable tempo at which the users can record their audio files, editable titles for the audio file, ability to attach notes to certain time points of the file, and the ability to categorize the notes into folders as the users see fit. Further, according to an embodiment, the exemplary software platform can layer recorded audio files on top of each other to properly express a user's ideas at a set tempo and layout, with the separate audio files being automatically synchronized by BPM and/or other criteria. According to an embodiment, the exemplary software platform can be used to record lectures, meetings, conversations, etc., and then efficiently categorizing, editing, and sharing the audio files. This software platform can be a stand-alone application or can be seamlessly integrated into existing software of the user's device.

According to one or more embodiments, the exemplary software platform can include a digital metronome, thereby allowing a user to set a predefined BPM using its voice. For example, in a first step, the user can use the mobile device (which implements the exemplary software platform) to specify the desired time signature with a voice command (for example: “Time Signature 4/4” (4 beats per minute), which can be displayed on the screen. In a second step, the user can then specify the BPM by using its voice to count out the beats into the software. For example, the user can say “One . . . Two . . . Three . . . Four . . . ” and the software can determine the distance in milliseconds between each of the peaks in the audio wave data above each peak indicator. In this regard, the faster the numbers are counted, the faster the tempo will be. This multi-step process allows users to set both the time signature and the tempo on their device (e.g., phone, laptop, computer, etc.) without touching the device, thereby simplifying the process of determining time signature and BPM.

According to one or more embodiments, related audio files can be saved/archived to a common session folder, thereby allowing users to retrieve, edit, and layer the related audio files as the user sees fit. Further, according to an embodiment, any edits to the common session folder, e.g., by the user who created the recording or another user, can result in the creation, e.g., by the exemplary software platform, of another session folder, thereby leaving original common session folder in its original form. In other words, after a user edits the common session folder, there will be at least two versions of the common session folder, e.g., the original common session folder and at least one edited common session folder.

According to one or more embodiments, the audio files can be edited using an exemplary editing software application. In this regard, the exemplary editing software application allows for the user to add notes (text) at selected points in the audio file, e.g., via the touch screen associated with the mobile device. As such, a user can record an audio file of herself humming a melody, which can then be synced to the selected and/or provided BPM, and then place notes (text) at select locations within the audio file (such as at or between beats) (e.g., describing the instruments to be involved or other instructions for the production). For example, the user can record an eight-bar loop of a hummed melody, and then write a note (text) on the third beat describing the tone and quality of that section. This allows the user to remember exactly what the user had intended at the point of the original recording to circle back to while producing the track later. In this regard, the exemplary editing software application allows for a user to zoom in and out of the timeline of audio file so that the user can notate specific points and/or time ranges in the audio file. The user can zoom in and out of the audio file by performing pinching in and pinching out motions on the touch screen/device. The audio file can visually get more detailed when zoomed in and the audio file can elongate when zoomed out. The exemplary editing software application can also include a horizontal scroll button just below the audio file so that the user is able to move around the audio file more efficiently. Further, after zooming in or out and/or scrolling until the user finds the exact location where it wants to write a note, the user can press a text tool to write a note. The exemplary software application can recognize and store that location into a chronological “Time Stamp” that can be easily retrieved in the session folder. Further, according to an embodiment, these notes can be kept and/or patched with the original audio file when shared with other users to ensure that the original file is maintained as intended while also being able to make and save changes separate from the original file.

Further, if a user wants to highlight three quotes in different parts of an audio file of a recorded meeting, the user can choose the location of the recording to provide a note, and the exemplary software application can recognize this selection and create time stamps of highlights or notes in the recording. Further, the user can later select the saved time stamp in order to go to the exact point of the original notation.

A user can upload any bar length (for example, 4, 8, or 16 bar sections) of their song into this exemplary software application that can randomly generate unique songs out of original content. This process will be called, for example, the “Randomly Generated Song Mashup”. The BPM of the song can be determined and notated by the processes described above. For example, a user uploads an 8-bar drumbeat, bassline, chord progression, guitar pattern, and piano solo. The user can set the desired time for the song. In this case, the user can select three minutes. The user can also select the desired number of versions of the song. In this case, the user can select 10 versions. The exemplary software application can then generate 10 unique versions of the 3-minute song using those original loops. The user can change the sections of the song to their liking using the PGM “Post-Generated Mashup” tool. The user can move, delete, and mute these 4, 8, or 16 bar loops to make these randomly generated versions achieve their desired sound. Audio files, such as vocals, can have the option of staying the same throughout the song and unedited by the exemplary software application or the user can opt for the software to generate new patterns to create unique content. The exemplary software application can give music creators the ability to randomly generate any number of desired versions, of specified length, using their own original uploaded content. A practical application of this invention is the randomly generated creation of versions of music which can individually become Non-Fungible Tokens (“NFTs”). Using the notation software application specified in [0007] and [0008], the user can attach text to each version that can be used for reference purposes later. In addition, each user of this application could select and order their preferences or “Grade the Versions”. This process could be used to choose which versions are the best and determine how often each is played. This process could also be opened to public or private voting by consumers, influencing the amount of play and value of each version. For example, a DJ performing a live event would be able to play versions of each song generated by this software application to create unique experiences for every audience. This can be a standalone process or easily integrated into existing software applications.

Further, according to one or more embodiments, the audio files can be saved in a manner that can be easily shared with other users of the exemplary software platform, which can be accessed, e.g., via a cloud-based computing platform/server. As such, multiple users can see the notes, synchronize the BPMs, separately edit the audio files (while maintaining the original copies), and create new session folders, thereby allowing the exemplary software platform to act as a hub for every user's session folders and corresponding audio files. In this regard, the session folders and audio files can be saved in a memory associated with the cloud-based computing platform/server. Accordingly, the session folders and audio files can also be accessed on desktop and laptop computers. Further, the session folders can have changes made by the other users without patching the original session folder. Further, according to another embodiments, the audio files can also be shared via email or text.

Further, according to one or more embodiments, the exemplary software platform can compress files when sent and decompress when they're being downloaded. For example, the exemplary software platform can automatically compress a folder or file if it's “dragged and dropped” into the exemplary software platform user interface, and can automatically decompress the file it's downloaded to another device, e.g., a desktop. This makes storage easier to manage across multiple devices and eliminates the process of manually compressing and decompressing files.

According to one or more embodiments, an audio synthesization system, comprises a mobile device. The mobile device is configured to: record a first audio file and a second audio file; overlay the second audio file over the first audio file to create a combined audio file; assign at least one textual note to at least one of the first audio file, the second audio file, and the combined audio file; and compress the combined audio file.

In one aspect, a computing device is in communication with the mobile device. The computing device is configured to: receive the compressed combined audio file from the mobile device, and decompress the compressed combined audio file.

In another aspect, the computing device is further configured to generate a copy of the decompressed combined audio file, and edit the copy based on a user-provided input to the computing device.

In another aspect, the computing device includes processing circuitry. The processing circuitry has a processor and a memory in communication with the processor.

In another aspect, the first audio file is recorded during a first period of time and the second audio file is recorded during a second period of time different than the first period of time.

In another aspect, the at least one textual note is assigned to at least one point in time in the combined audio file.

In another aspect, the mobile device is further configured to assign at least one textual note to at least one of the first audio file and the second audio file prior to creating the combined audio file.

In another aspect, the mobile device is further configured to record a user voice input, correlate the user voice input to a predetermined command, and perform at least one action based on the correlation.

According to one or more embodiments, a system for dynamically synthesizing audio files on a mobile device comprises a computing device and a mobile device in communication with the computing device. The mobile device is configured to: record a first audio file and a second audio file; overlay the second audio file over the first audio file to create a combined audio file; assign at least one textual note to at least one point in time in the combined audio file; compress the combined audio file; and transmit the compressed combined audio file to the computing device.

In one aspect, the computing device includes processing circuitry configured to: receive the compressed combined audio file from the mobile device; decompress the compressed combined audio file; generate a copy of the decompressed combined audio file; and edit the copy based on a user-provided input to the computing device.

In another aspect, the computing device is further configured to assign at least one textual note to at least one point in time in the copy, compress the copy, and transmit the compressed copy to a second computing device configured to receive the compressed copy.

In another aspect, the first audio file is recorded during a first period of time and the second audio file is recorded during a second period of time different than the first period of time.

In another aspect, the mobile device is further configured to assign at least one textual note to at least one of the first audio file and the second audio file prior to creating the combined audio file.

In another aspect, the mobile device further includes a microphone configured to record a user voice input.

In another aspect, the mobile device is further configured to correlate the user voice input to a predetermined command and perform at least one action based on the correlation.

In another aspect, the at least one action includes at least one of: (a) assigning a desired time signature to at least one of the first audio file, the second audio file, and the combined audio file; and (b) assigning a desired beats per minute to at least one of the first audio file, the second audio file, and the combined audio file.

According to one or more embodiments, a method for dynamically synthesizing audio files on a mobile device comprises: recording, with a mobile device, a first audio file and a second audio file. The first audio file is recorded during a first period of time and the second audio file is recorded during a second period of time. The first period of time and the second period of time are different. The method further includes: overlaying, with the mobile device, the second audio file over the first audio file to create a combined audio file; assigning, with the mobile device, at least one textual note to at least one point in time in the combined audio file; compressing, with the mobile device, the combined audio file; and transmitting, with the mobile device, the compressed combined audio file to a computing device.

In another aspect, the method further includes: decompressing, with the computing device, the compressed combined audio file; generating, with the computing device, a copy of the decompressed combined audio file; and editing, with the computing device, the copy based on a user-provided input to the computing device.

In another aspect, the method further includes: recording, with the mobile device, a user voice input; correlating, with the mobile device, the user voice input to a predetermined command; and performing, with mobile device, at least one action based on the correlation.

In another aspect, the at least one action includes at least one of: (a) assigning a desired time signature to at least one of the first audio file, the second audio file, and the combined audio file; and (b) assigning a desired beats per minute to at least one of the first audio file, the second audio file, and the combined audio file.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features, and advantages of the present disclosure will become apparent from the following detailed description taken in conjunction with the accompanying Figure showing illustrative embodiments of the present disclosure.

FIG. 1 depicts an exemplary system according to an embodiment of the present invention;

FIG. 2 depicts an interaction of the components depicted in FIG. 1 according to an embodiment of the present invention;

FIG. 3 depicts an exemplary use of the mobile device in FIG. 1 according to an embodiment of the present invention;

FIG. 4 depicts a digital metronome according to an embodiment of the present invention;

FIG. 5 depicts a block diagram of the mobile device in FIG. 1 according to an embodiment of the present invention; and

FIG. 6 depicts a block diagram of the secondary device in FIG. 1 according to an embodiment of the present invention.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

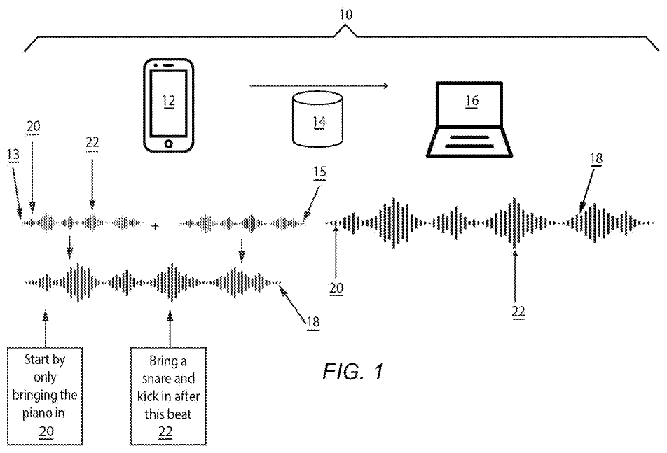

FIG. 1 depicts an exemplary system according to an embodiment of the present invention. According to an embodiment, an exemplary system 10 can include a primary device 12 such as, for example, a mobile device (e.g., mobile phone, laptop, tablet/iPad®, etc.), a cloud-based computing platform/server 14, and one or more secondary devices 16 (e.g., desktop, mobile phone, laptop, tablet/iPad®, etc.). The primary device 12 and/or secondary device 16 are each configured and/or programmed to implement the exemplary software platform 14 described for synthesizing audio files. In this regard, FIG. 1 depicts that the primary device 12 is a mobile device, such as a mobile phone, and that the secondary device 16 is a laptop. As such, primary device 12 may be referred to herein as mobile device 12, and secondary device 16 may be referred to herein as laptop 16 for ease of understanding. According to some embodiments, the components of the exemplary system 10 can be used as follows: (i) a user of the mobile device 12 can record a first audio file 13 of herself humming a melody to a set tempo; (ii) the user of the mobile device 12 can add a first note 20 attached to the beginning of the first audio file 13 that says “start by only bringing the piano in” and can attach a second note 22 to another point in the first audio file 13 that says “bring a snare and kick in after this beat,” as depicted in FIG. 1; (iii) the user of the mobile device 12 can then record another second audio file 15, e.g., “beat box” (where the user makes drum noises with their mouth) over the original first audio file 13 to create an “overlaid” or combined audio file 18 that includes the first and second notes 20, 22; (iv) the user (e.g., user 1) of the mobile device 12 can then name this project, e.g., “song in park,” and then send the overlaid audio file 18, e.g., via email, text, or the cloud-based computing platform/server 14, to another user (e.g., user 2), which may be associated with the secondary device 16 (e.g., laptop); (v) user 2 can then open the audio file 18 and access the same session folder with the same audio files, notes, tempo, and song name; (vi) and user 2 can then provide their own edits to the audio file 18 and/or session folder and then save the edits without patching the original folder sent. Further, as depicted in FIG. 1, user 2 is able zoom into the audio file 18 in order to make particular edits (e.g., separate the file, trim the file, scroll across the audio file, notate specific points in the file, etc.) to it.

As described herein, it is to be understood that the first note 20 and second note 22 may be attached to either first audio file 13, the second audio file 15, and/or the combined audio file 18 at any stage. In other words, the first and second notes 20, 22 can be attached to the combined audio file 18 prior to, or after, the first audio file 13 has been overlaid by the second audio file 15.

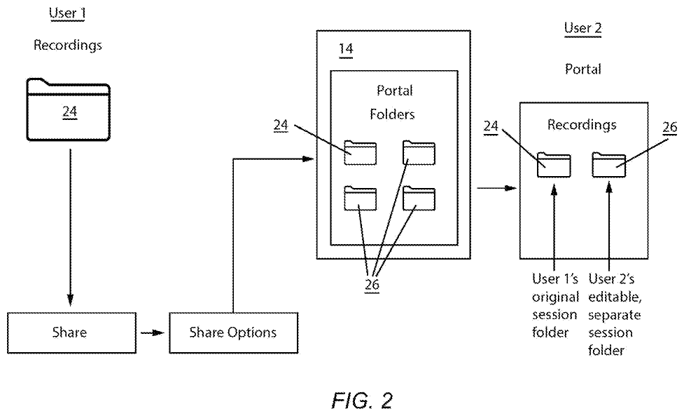

FIG. 2 depicts an interaction of the components depicted in FIG. 1 according to an embodiment of the present invention. According to an embodiment, as depicted in the figure, after a user makes a combined audio file 18 with a mobile device 12 using the process described above, the user can save the combined audio file 18 of the recording in one or more session folders 24. The session folders 24 can contain audio files as well as data related to notation, BPM, date, name, and other characteristics. Further, according to some embodiments, the user can choose to save the combined audio file 18 on the mobile device 12 and/or share the combined audio file 18 and associated data through the cloud-based computing platform/server 14. In this regard, if the user chooses to share the session folder 24 via the cloud-based computing platform/server 14, the exemplary software platform of the mobile device 12 can automatically compress the session folder 24, e.g., into a Zip file. The user can then access this folder on any other secondary device 16 that is connected to the cloud-based computing platform/server 14. Accordingly, when accessed on another device, the exemplary software platform can automatically decompress the session folder 24. Further, the user can also share the session folder 24 with another user, e.g., via the cloud-based computing platform/server 14, email, text, etc. In this regard, the session folder 24 can also be automatically compressed when sent by the user and automatically decompressed when accessed by the other user. Further, according to another embodiment, the user can also share single audio files to efficiently transport files to other users without using another device.

Continuing to refer to FIG. 2, it is to be understood that once the audio files 13, 15, and/or 18 are recorded by the mobile device 12, and the user (user 1) is satisfied with its edits to the audio files, the session folder 24 can be saved on the mobile device 12. The session folder 24 contains a log of all of the user's actions during a particular session (e.g., audio files, edits, time stamps, notations, and other relevant information the user sees fit). When user 1 wishes to share the session folder 24 with another user (user 2), the original session folder 24 of user 1 can be stored within the mobile device 12 and one or more duplicate “patch session folders” 26 can be created that allows user 2 to edit the duplicated patch session folder(s) 26, rather than the original session folder 24 of user 1. This enables user 1 and user 2 to separately keep track of the original and new session folder(s) 24, 26, and to separately identify the content and edits made by each different user. In addition to saving session folders on the corresponding device of each user, users also have the option of having the session folder save in the cloud-based computing platform/server 14. The session folder on the corresponding devices and/or server would contain all recordings, notes, and time stamps, BPMs, and all other relevant information to each relevant user.

It is to be understood that the server 14 is configured to store or archive audio files to the session folder 24, thereby allowing users to retrieve, edit, and layer the related audio files as the users see fit from a common portal. In some embodiments, any edits to the session folder 24, e.g., by the user who created the recording (user 1) or another user (user 2), can result in the creation, e.g., by the exemplary software platform, of the duplicate patch session folder 26, thereby leaving original session folder 24 in its original form. In other words, after a user edits the session folder 24, there can be at least two versions of the session folder, e.g., the original session folder 24 and at least one edited duplicate patch session folder 26. Further, the server 14 can allow a user to hold the session folder 24 in manner that would not occupy storage space on the user's device because the session folder 24 can be stored and accessed in the “cloud.” Search capabilities for session folders 24, 26 may include the name of any user who has worked on and/or shared the folder. The result is a virtual studio environment with all content stored in the “cloud” and accessible by authorized users. Each access and edit shall be documented with a keystroke-by-keystroke, time-stamped audit trail.

Accordingly, users are able to record, layer, organize, notate, and share session folders with any other desired user in the world.

According to one or more embodiments, the files on the server 14 may also be dragged and dropped using a touch screen, a mouse, or any other means or user interface to any destination on a computer, laptop, or other device. When creating music or transferring audio files people have run into the issue of not being able to easily revert to the original folder where the first content was stored. This allows for users to easily keep track of their versions and edits, including who has contributed to each version and at which point in the process, and also provides a simplified way to revert to the original session folder.

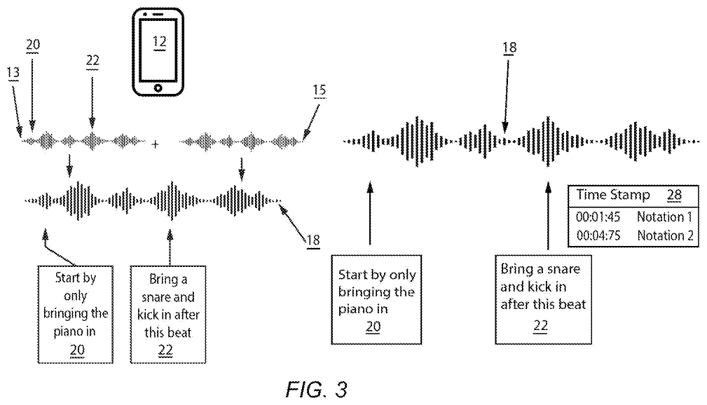

FIG. 3 depicts an exemplary use of the mobile device in FIG. 1 according to an embodiment of the present invention. According to an embodiment, the mobile device 12 can be used as follows: (i) a user of the mobile device 12 can record a first audio file 13 of herself humming a melody to a set tempo; (ii) the user of the mobile device 12 can add a first note 20 attached to a first point of the audio file 13 that says “start by only bringing the piano in” and can attach a second note 22 to a second point in the audio file 13 that says “bring a snare and kick in after this beat,” as depicted in FIG. 3; and (iii) the mobile device 12 can automatically generate and/or log a time stamp 28 (discussed in more detail below) associated with each note 20, 22 at the first and second points of the audio file 18. Additionally and/or alternatively, as shown in FIG. 3, in some embodiments, the components of the exemplary system 10 can be further used as follows: (iv) the user of the mobile device can then record a second audio file 15, e.g., “beat box” (where the user makes drum noises with their mouth) over the first audio file 13 to create the “overlaid” or combined audio file 18 that includes the first and second notes 20, 22; (v) the user of the mobile device 12 can then name this project, e.g., “song in park,” and then send the combined audio file 18, e.g., via email, text, or the cloud-based computing platform/server 14, to another user, which may be associated with the secondary device 16 (e.g., laptop); (vi) the other user can then open the audio file 18 and access the same session folder 24 with the same audio files, notes, tempo, and song name; (vii) and the other user can then provide their own edits to the audio file 18 and/or session folder 24 and then save the edits without patching the original folder sent. Further, as depicted in the figure, the other user is able zoom into the audio file 18 in order to make particular edits (e.g., separate the file, trim the file, scroll across the audio file, notate specific points in the file, etc.) to it.

As mentioned above, in one or more embodiments, once an audio file 13, 15, and/or 18 is created the user can add text in the form of a note to specific points of the audio file and have the text stored as time stamps. For example, once the user has created a combined audio file 18 and then writes text in a first note 20 at a first point of the audio file 18 (e.g., 1.45 second mark), a second note 22 at a second point 22 of the audio file 18 (e.g., 4.75 second mark), and a third note (not shown) at a third point of the audio file 18 (e.g., 24.44 second mark). The user may also zoom in and out of the audio file 18 to choose the exact location for the text by pinching in and out with their fingers on a touch screen interface of the mobile or secondary devices 12, 16, or by pressing zoom in and out buttons on a non-touch screen mobile or secondary device 12, 16. The second marks written on the audio file 18 can be stored in chronological order as time stamps in a log 28. The user may then press on the time stamps listed and whichever stamp the user presses will bring the user to that exact location in the audio file 18 where the text of the corresponding note is. The user can then initiate the playing of the audio file 18 from that exact text spot after pressing on the specified time stamp 28. The users may also rename the time stamps to specific names rather than the marked time to make it easier to keep track of their text.

According to one or more embodiments, the time stamps can be renamed by pressing on the “time stamp” and selecting an option to rename the time stamp. The user can type in whatever it wants that particular time stamp to be called. The user can also color code the time stamps if they desire that for an easier retrieval process. The time stamps can be color coded by pressing on the time stamp and selecting the option to color code. Upon the selection of this option, the user can be presented with an array of colors to choose from for that particular time stamp. These time stamps can be stored in the user's session folder 24 that contains all content for that recording. This allows users to resort back to their recordings and easily retrieve their notes in this efficient new process using time stamps.

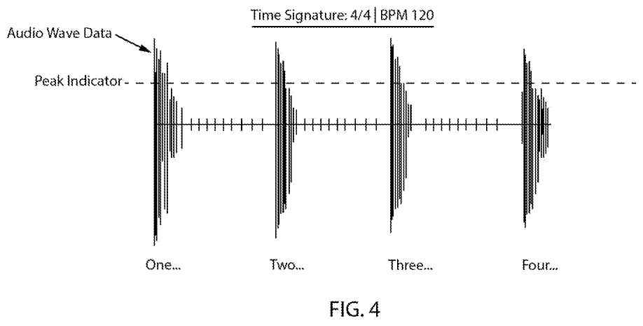

FIG. 4 depicts a digital metronome according to an embodiment of the present invention. According to the embodiment, as depicted in the figure, the exemplary software platform can include a digital metronome, thereby allowing a user to set a predefined BPM using their voice. For example, in a first step, the user can use the software platform to specify the desired time signature with a voice command (for example: “Time Signature 4/4” (4 Beats per Minute), which can be displayed on the screen. In a second step, the user can then specify the BPM by using its voice to count out the beats into the exemplary software platform. For example, the user can say “One . . . Two . . . Three . . . Four . . . ” and the exemplary software platform can determine the distance in milliseconds between each of the peaks in the audio wave data above each peak indicator. In this regard, the faster the numbers are counted, the faster the tempo will be. Thus, this embodiment allows users to set both the time signature and the tempo on their device (e.g., phone, laptop, computer, etc.) without touching the device, thereby simplifying the process of determining time signature and BPM.

As described herein, the voice command from the user may be initiated by activating a Voice Time Signature button (not shown) (or any other similar option) built into the software platform of the exemplary system, or by initiating a built-in, voice-controlled personal assistant (e.g., Siri®, Cortana®, etc.) of the mobile device that is configured and programmed to sense and react to the user's voice command. Once the user's voice is sensed by the mobile device 12, the mobile device 12 can record the user's voice with the device's microphone (microphones 33 and/or 43 discussed in more detail below) and analyze the user's voice using the exemplary software platform of the present invention. Once the voice command is analyzed, the time signature can be displayed on the screen. Additionally, the user may engage the Voice Time Signature button or the built-in, voice-controlled personal assistant of the mobile device to specify the BPM using the user's voice. Once the user's voice is sensed by the mobile device 12, the mobile device 12 can record the user's voice with the device's microphone and analyze the user's voice using the exemplary software platform of the mobile device 12. Once the voice command is analyzed, the mobile device can determine the average distance in milliseconds between the audio's amplitude using the peak indicator illustrated in FIG. 4. After analyzing the average distance, the screen of the mobile device can display the BPM. This process allows for a more efficient way of displaying the time signature and BPM with a hands-free option. The hands-free approach is useful to user's not in direct physical contact with a mobile device 12 and/or secondary device 16. For example, musicians and artists may often be in different rooms within a studio, or in multiple locations. Without having to always walk to the mobile device 12 (such as in a studio control room), users can simply dictate the time signature and BPM from any room with a microphone or other similar voice recording equipment. This allows for more streamlined workflow and efficiency.

According to one or more embodiments, the mobile device 12 and/or secondary device 16 are each configured to enable a user to create audio that corresponds to a set Time Signature and BPM, or allows the user to upload their own audio to the device. For example, the mobile device is configured to generate a randomly-generated “mashup song” using these created or uploaded audio files. The mobile device and/or secondary device are configured to enable the user to select the desired length of the song by typing in the length parameters in minutes and seconds.

As described above, in one or more embodiments, a user can record or upload to the mobile device, which can randomly generate unique songs out of original content. In one example, the user can upload an 8-bar loop of a drumbeat, bassline, chord progression, guitar pattern, and/or piano solo. The user can select to make a 3-minute song on the mobile device. The user can then select the number of versions they want to generate by typing in the number of versions. In this example, the user enters 10 versions. The mobile device can generate 10 unique versions of the 3-minute song using the original loops. The mobile device is configured such that the user can change the sections of the song to their liking by enabling the user to move, delete, and mute the loops to make the randomly generated versions achieve their desired sound. Audio files, such as vocals, can have the option of staying the same throughout the song and unedited by the mobile device or the user can opt for the mobile device to generate new patterns to create unique content. Thus, the mobile device provides music creators the ability to randomly generate any number of desired versions, of specified length, using their own original uploaded content. This allows creators to revision their music creation abilities. The BPM of the song can be determined using the processes described herein and can also be notated as described herein. Additionally, in some embodiments, the mobile device is configured to enable the user to attach notes and text to edit each generated song using the process described herein. The user (such as, for example, a DJ, music producer, audio engineer, or entertainer) can use text to “Grade the Versions” to express which versions of the song sound the best and which can be more valuable to potential consumers. For example, a DJ could play songs at events, but every event could hear a different version of each song, which means no audience will have exactly the same overall experience, making each event truly unique. Songs can be randomly generated from a centralized set of content using the systems described herein.

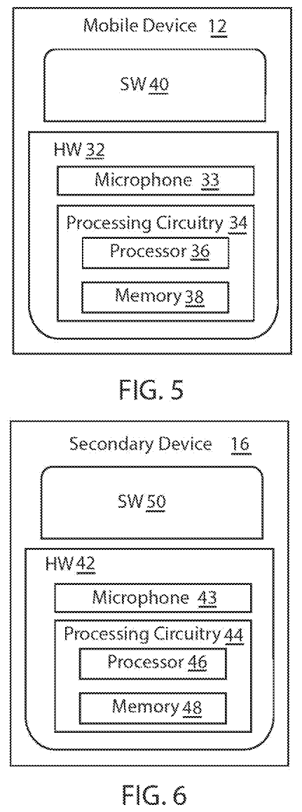

FIG. 5 depicts a block diagram of the mobile device in FIG. 1 according to an embodiment of the present invention. According to an embodiment, the mobile device 12 is configured to include hardware 32. The hardware 32 may include a microphone 33 configured to perform the voice recording and dictation functions described above, and processing circuitry 34 in communication with the microphone 33, which may include a processor 36 and a memory 38. In particular, in addition to or instead of a processor 36, such as a central processing unit and memory, the processing circuitry 34 may include integrated circuitry for processing and/or control, e.g., one or more processors and/or processor cores and/or FPGAs (Field Programmable Gate Array) and/or ASIC's (Application Specified Integrated Circuitry) adapted to execute instructions. The processor 36 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPRO (Erasable Programmable Read-Only Memory). Further, the memory 38 may be configured as a storage device.

The mobile device 12 is also configured to include software (SW) 40. The software 40 is stored internally in, for example, the memory 38, or stored in external memory (e.g., database, storage array, network storage device, etc.) and may be accessible by the mobile device 12 via an external connection. The software 40 may be executable by the processing circuitry 34.

The processing circuitry 34 may be configured to control any of the methods and/or processes described herein and/or to cause such methods, and/or processes to be performed, e.g., by the mobile device 12. The processor 36 corresponds to one or more processors for performing mobile device 12 functions described herein. In some embodiments, the software 40 may include instructions that, when executed by the processor and/or processing circuitry, causes the processor 36 and/or processing circuitry 34 to perform the processes described herein with respect to the mobile device 12.

FIG. 6 depicts a block diagram of the secondary device in FIG. 1 according to an embodiment of the present invention. According to an embodiment, the secondary device 16 (e.g., desktop, mobile phone, laptop, iPad®, etc.) of the exemplary system is configured to include hardware 42. The hardware 42 may include a microphone 43 configured to perform the voice recording and dictation functions described above in regards to the secondary device 16, and processing circuitry 44 in communication with the microphone 43, which may include a processor 46 and a memory 48. In particular, in addition to or instead of a processor 46, such as a central processing unit and memory, the processing circuitry 44 may include integrated circuitry for processing and/or control, e.g., one or more processors and/or processor cores and/or FPGAs (Field Programmable Gate Array) and/or ASIC's (Application Specified Integrated Circuitry) adapted to execute instructions. The processor 46 may be configured to access (e.g., write to and/or read from) the memory 48, which may comprise any kind of volatile and/or nonvolatile memory, e.g., cache and/or buffer memory and/or RAM (Random Access Memory) and/or ROM (Read-Only Memory) and/or optical memory and/or EPRO (Erasable Programmable Read-Only Memory). Further, the memory 48 may be configured as a storage device.

The secondary device 16 is also configured to include software 50. The software is stored internally in, for example, the memory 48, or stored in external memory (e.g., database, storage array, network storage device, etc.) and may be accessible by the secondary device 16 via an external connection. The software 50 may be executable by the processing circuitry 44.

The processing circuitry 44 may be configured to control any of the methods and/or processes described herein and/or to cause such methods, and/or processes to be performed, e.g., by the secondary device 16. The processor 46 corresponds to one or more processors for performing secondary device functions described herein. In some embodiments, the software 50 may include instructions that, when executed by the processor 46 and/or processing circuitry 44, causes the processor 46 and/or processing circuitry 44 to perform the processes described herein with respect to the secondary device 16.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information.

It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. An audio synthesization system, comprising:
a mobile device, the mobile device being configured to:
record a first audio file and a second audio file;
overlay the second audio file over the first audio file to create a combined audio file;
assign at least one textual note to at least one of the first audio file, the second audio file, and the combined audio file; and
compress the combined audio file.

2. The system of claim 1, further including:
a computing device in communication with the mobile device, the computing device being configured to:
receive the compressed combined audio file from the mobile device; and
decompress the compressed combined audio file.

3. The system of claim 2, wherein the computing device is further configured to:
generate a copy of the decompressed combined audio file; and
edit the copy based on a user-provided input to the computing device.

4. The system of claim 3, wherein the computing device includes processing circuitry, the processing circuitry having:
a processor; and
a memory in communication with the processor.

5. The system of claim 1, wherein the first audio file is recorded during a first period of time and the second audio file is recorded during a second period of time different than the first period of time.

6. The system of claim 1, wherein the at least one textual note is assigned to at least one point in time in the combined audio file.

7. The system of claim 1, wherein the mobile device is further configured to assign at least one textual note to at least one of the first audio file and the second audio file prior to creating the combined audio file.

8. The system of claim 1, wherein the mobile device is further configured to:
record a user voice input;
correlate the user voice input to a predetermined command; and
perform at least one action based on the correlation.

9. A system for dynamically synthesizing audio files on a mobile device, the system comprising:
a computing device; and
a mobile device in communication with the computing device, the mobile device being configured to:
record a first audio file and a second audio file;
overlay the second audio file over the first audio file to create a combined audio file;
assign at least one textual note to at least one point in time in the combined audio file;
compress the combined audio file; and
transmit the compressed combined audio file to the computing device.

10. The system of claim 9, wherein the computing device includes processing circuitry configured to:
receive the compressed combined audio file from the mobile device;
decompress the compressed combined audio file;
generate a copy of the decompressed combined audio file; and
edit the copy based on a user-provided input to the computing device.

11. The system of claim 10, wherein the computing device is further configured to:
assign at least one textual note to at least one point in time in the copy;
compress the copy; and
transmit the compressed copy to a second computing device configured to receive the compressed copy.

12. The system of claim 9, wherein the first audio file is recorded during a first period of time and the second audio file is recorded during a second period of time different than the first period of time.

13. The system of claim 9, wherein the mobile device is further configured to assign at least one textual note to at least one of the first audio file and the second audio file prior to creating the combined audio file.

14. The system of claim 9, wherein the mobile device further includes a microphone configured to record a user voice input.

15. The system of claim 14, wherein the mobile device is further configured to:
correlate the user voice input to a predetermined command; and
perform at least one action based on the correlation.

16. The system of claim 15, wherein the at least one action includes at least one of:
(a) assigning a desired time signature to at least one of the first audio file, the second audio file, and the combined audio file; and
(b) assigning a desired beats per minute to at least one of the first audio file, the second audio file, and the combined audio file.

17. A method for dynamically synthesizing audio files on a mobile device, the method comprising:
recording, with a mobile device, a first audio file and a second audio file, the first audio file is recorded during a first period of time and the second audio file is recorded during a second period of time, wherein the first period of time and the second period of time are different;
overlaying, with the mobile device, the second audio file over the first audio file to create a combined audio file;
assigning, with the mobile device, at least one textual note to at least one point in time in the combined audio file;
compressing, with the mobile device, the combined audio file; and
transmitting, with the mobile device, the compressed combined audio file to a computing device.

18. The method of claim 17, further including:
decompressing, with the computing device, the compressed combined audio file;
generating, with the computing device, a copy of the decompressed combined audio file; and
editing, with the computing device, the copy based on a user-provided input to the computing device.

19. The method of claim 18, further including:
recording, with the mobile device, a user voice input;
correlating, with the mobile device, the user voice input to a predetermined command; and
performing, with mobile device, at least one action based on the correlation.

20. The method of claim 19, wherein the at least one action includes at least one of:
(a) assigning a desired time signature to at least one of the first audio file, the second audio file, and the combined audio file; and
(b) assigning a desired beats per minute to at least one of the first audio file, the second audio file, and the combined audio file.
